(19) United States
(12) Patent Application Publication
(10) Pub. No.: US 2004/0153469 A1
(43) Pub. Date: Aug. 5, 2004

(54) Database comparator

(76) Inventor: Roderic M. Keith-Hill, Devon (GB)

Correspondence Address: SCHNECK & SCHNECK, P.O. BOX 2-E, SAN JOSE, CA, 95109-0005, US

(21) Appl. No.: 10/627,325

(22) Filed: Jul. 24, 2003

(30) Foreign Application Priority Data
Jul. 24, 2002 (GB) 0217201.3

(51) Int. Cl. G06F 17/00

(52) U.S. Cl. 707/101

(57) ABSTRACT

A preferred embodiment of the invention pertains to a method of comparing first and second databases (DB1, DB2) that are each comprised of a plurality of entities (A to E) having one or more characteristics, said entities being grouped into a plurality of data classes in each said database each representative of a particular entity type; the method comprising: (i) for each said data class of said first and second databases, compiling a list representative of the entities occurring within that class and the attributes for each said entity; (ii) identifying and comparing corresponding data classes for each of said first and second databases; and (iii) identifying on the basis of said comparison differences between corresponding entities of said corresponding data classes. A computer program, and storage medium are also disclosed.

### FIELD OF THE INVENTION

This invention relates to database comparators in general, and particularly—but not exclusively—to database comparators implemented in software.

One presently preferred aspect of the present invention relates to a method of comparing databases—particularly relational databases. Another aspect of the present invention relates to a storage medium encoded with machine readable code that is operable to implement the aforementioned method. Yet another aspect of the present invention relates to a computer program, particularly but not exclusively to an object orientated computer program.

### BACKGROUND TO THE INVENTION

Databases are used in many organisations to store data in an ordered and structured manner. In a relational database there are typically a plurality of data entities that are each characterised by one or more items of data which define the properties or characteristics (often referred to as “values”) of those data entities.

In a typical database, individual characteristics of each data entity are held in fields, and discrete fields are grouped to provide a record that defines all the characteristics of a specific data entity. These records are often presented in a tabular form, where the columns of the table typically define the characteristics of the data entities, and the rows of the table pertain to particular data entities.

To implement such data storage structures in an efficient manner, and in particular to reduce the number of instances of “null” fields, it is commonplace to group entities by type, so that a number of tables—as aforementioned—are provided, each said table being comprised of records (i.e. entities) of a particular type.

In general terms, the content of a database can be viewed as a hierarchy of data collections, and this hierarchical structure can be represented by a plan which describes inter alia the data the database may contain, their types, formats, representation and relationships. In the art, such “plans” are typically known as “schema”.

In an object orientated programming environment, these tables are often referred to as “object classes”, and the individual data entities (expressed as rows in the aforementioned tables) are typically referred to as “objects”.

During the life-cycle of any design project, it is not unusual for changes to be made which necessitate corresponding changes to the structure and/or stored data values of a database describing the project. The necessity for such changes may occur, for example, as the design evolves, corrections are made, or variants are required. In the context of the database, it is not unusual for entity types, data types and relationships to be added, modified or deleted as the database schema itself grows and evolves.

The design and construction of an embedded system (such as a complicated integrated circuit) provides an illustrative example of just such a project. As technology has advanced, larger and more complex electronic circuit designs can be formed as a single integrated circuit (IC), and these advances, coupled with an increasing need to get products to market quickly, have forced designers to find new ways of quickly developing and testing electronic products.

As a means to help reduce the development time for a new product, designers have recognised that they will often have to concurrently develop the software and hardware for a given new product. To help this process, a number of tools have been designed that enable a system architect to specify a system design without having to worry about dividing the system into software and hardware. However, before a new system can be implemented a division between the hardware and the software must be specified.

At this point in the development process, software development and hardware development generally follow separate paths. The hardware and software designers will both be given a copy of the system specification created by the system architect, and then each team tends to develop and verify their bit of the system independently from the other. Once development is complete the two parts of the system are then re-united.

A major drawback of this method is there are many opportunities for information, such as the system specification for example, to be incorrectly reproduced or misinterpreted. It is also the case that changes are often made to the hardware or software specification as a project progresses, and these specification changes can often be mis-communicated, or not communicated at all, between the design teams. A lack of communication between the teams can cause serious problems during the subsequent system integration phase when the hardware and software designs are re-united.

In an effort to alleviate such problems it has become commonplace to implement the aforementioned specification as a database which includes all of the information that defines the structure and composition of the aforementioned hardware and software. The independent hardware and software teams can each then refer to a common source, namely the database, for information pertaining to the project.

However, as explained above, it is usually the case that the design of—in this example—the IC and other aspects of the project will change over time as the project progresses, and to maintain an accurate description of the project it is necessary for these changes to be reflected in the database to which the teams refer.

Implementing changes to the data and/or data structure of the database is relatively easy to accomplish. However, it is critical that any such changes are properly managed. For example, it is usual for versions of the database to be saved or archived (along with schematic information) from time to time, and as such it is important to be able to ensure that it is possible to identify differences between one version and another. It is immediately apparent that serious problems could result if the two teams aforementioned were to inadvertently work from versions of the database which appeared to be identical but were in fact different. Furthermore, a proper recording of change is essential if it is to be possible to revert from a current version of a database to an earlier version, should such a reversion be required in the course of a given project.

It is apparent, therefore, that it is important to provide a means of determining absolutely and accurately the differences between databases, such as for example two versions of a database, and it is preferable for means to be provided that enables the proper recording of when—and under what circumstances—a comparison was performed.

There are several problems surrounding the comparison of databases with a view to determining, preferably in detail, the differences between them.

One major bar to the effective comparison of databases is the fact that these databases tend to be large and complex in nature. As a consequence of this, a manual comparison would be a difficult, laborious, time-consuming and highly error-prone task to undertake. As many such comparisons will have to be made in the course of any one project, it is apparent that a manual comparison is simply not an effective proposal.

To avoid a manual comparison, it is possible to provide a comparison tool (referred to hereafter as a “comparator”) implemented, for example, as software which is operable to automatically compare two or more databases. However, the automation of such an involved process is not without its own set of difficulties and problems.

For example, a common problem is that it is preferable for a common format—in which to represent the data contained in the databases for comparison—to be established, as the database management software and comparison tools may be remote from each other or hosted on platforms of different type. Indeed, the two databases themselves may originate from tools running on different platforms. It is preferable, therefore, for this format to be non-proprietary and platform-independent. Ideally, the comparison tool should also be non-proprietary and platform-independent.

U.S. Pat. No. 6,502,112 (to Baisley, and assigned to Unisys Corporation), provides one such comparator which, whilst going some way to alleviating these problems, still suffers from a number of serious drawbacks. For example, this particular tool is dependent on a number of complex and involved algorithms which function, inter alia, to create semantic graphs and to sort data objects. The creation of semantic graphs and subsequent sorting of data objects is necessarily a task which requires a great deal of processing, and as such the tool disclosed is relatively slow in operation.

A further problem is that the sole determination provided by the tool is “documents equal” or “documents unequal”. Whilst this might seem at first sight to be of assistance, it is in fact of little real assistance to the individual charged with comparing the databases. Databases typically contain many thousands of objects, and to be advised that two databases are unequal without any sort of indication as to where the inequalities might lie is not a response that one might describe as being particularly helpful. As a consequence, it is the case that with this particular system it is still necessary for the operator to manually identify which objects give rise to a detected inequality, and more particularly to identify how common objects have been modified as between one database and the other.

### OBJECTS & STATEMENT OF INVENTION

It is an aim of the present invention to avoid or alleviate one or more of the problems outlined above.

It is a particular aim of the present invention to provide a system which reliably and accurately identifies differences between databases.

To this end, one presently preferred aspect of the invention provides a method of comparing first and second databases that are each comprised of a plurality of entities having one or more characteristics, said entities being grouped into a plurality of data classes in each said database each representative of a particular entity type; the method comprising: (i) for each said data class of said first and second databases, compiling a list representative of the entities occurring within that class and the attributes for each said entity; (ii) identifying and comparing corresponding data classes for each of said first and second databases; and (iii) identifying on the basis of said comparison differences between corresponding entities of said corresponding data classes.

This aspect of the invention is advantageous in that it provides for the identification of the particular differences, if any, between corresponding entities of said two databases. Furthermore, the compilation of lists is much less processor intensive than, for example, the complex algorithms employed in the aforementioned prior U.S. patent to generate semantic graphs and to order database objects. As such, the tool of the invention can function much more quickly than the tool of the prior art.

A further aspect of the present invention provides a storage medium encoded with machine readable computer program code for comparing first and second databases that are each comprised of a plurality of entities having one or more characteristics, said entities being grouped into a plurality of data classes in each said database each representative of a particular entity type; wherein, when the computer program code is executed by a computer, the computer performs the steps of: (i) for each said data class of said first and second databases, compiling a list representative of the entities occurring within that class and the attributes for each said entity; (ii) identifying and comparing corresponding data classes for each of said first and second databases; and (iii) identifying on the basis of said comparison differences between corresponding entities of said corresponding data classes.

Another aspect of the invention provides a method of comparing first and second databases that are each comprised of a plurality of entities having one or more characteristics, the method comprising: (i) for each of said first and second databases, compiling a list representative of the entities occurring within that database and the attributes for each said entity; (ii) identifying and comparing corresponding entities of said first and second databases; and (iii) identifying on the basis of said comparison differences between corresponding entities of said databases.

Further aspects of the present invention, and preferred features of those aspects, are set out in the accompanying claims and elsewhere in the following description.

### BRIEF DESCRIPTION OF THE DRAWINGS

FIG. 1 is a schematic representation of a computer system which is capable of implementing the teachings of an embodiment of the invention.

FIG. 2 is a schematic representation of the steps of a method in accordance with an embodiment of the invention.

FIG. 3 is a pictorial representation of the method of the invention.

FIGS. 4a and 4b are flow diagrams illustrating the steps of part of the method.

FIG. 5 is a high-level diagram of the comparison process.

FIG. 6 is a diagram illustrating multiple databases that conform to different version of the same schema.

FIG. 7 (on sheets 6 to 14) is a report generated in accordance with the principles of the invention.

### DETAILED DESCRIPTION OF THE PREFERRED EMBODIMENT GENERIC DESCRIPTION

There now follows a generic description highlighting the principles of the present invention, and the manner in which it functions. In this generic description, particular emphasis will be placed on XML documents and object based programming in the context of a software tool. It will be apparent, however, to those persons skilled in the art that the teachings of the invention may equally be applied to a hardware tool, or indeed to a software tool operating under a different programming language, or on a differently formatted database.

The following description will also refer, by way of illustrative example only, to a comparison of two versions of the same database DB1 and DB2, referred to hereafter as an “older” database and a “newer” database respectively.

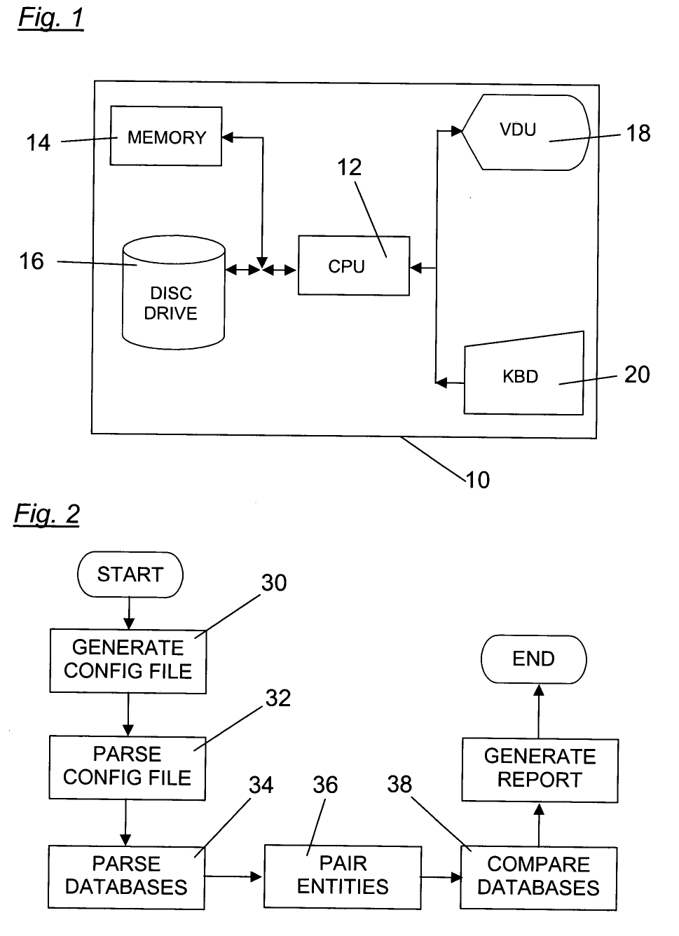

FIG. 1 is a schematic illustration of a computing resource 10, such as a personal computer for example, that is operable to implement the teachings of the invention. The resource 10 comprises a central processing unit (CPU) 12, a memory 14, a disc drive 16, a visual display unit (VDU) 18, and a keyboard 20. These elements are interconnected via a conventional bus structure (not shown). Other elements, such as a mouse, will also most probably be provided.

Within the memory 16 of the computing resource, a plurality of control programs—including for example an operating system—are stored for execution. These programs, on execution, provide an operating environment for the software of the invention.

As mentioned above, a relational database typically comprises a plurality of data entities that are each characterised by one or more items of data which define the properties or characteristics (often referred to as “values”) of those data entities. In a typical database, individual characteristics of each data entity are held in fields, and discrete fields are grouped to provide a record that defines all the characteristics of a specific data entity. These records are often presented in a tabular form, where the columns of the table typically define the characteristics of the data entities, and the rows of the table pertain to particular data entities. Individual records in any one table may include links to one or more records in other tables, thereby implementing the aforementioned relational data structure.

For the purposes of this generic description it is appropriate to consider the two databases under comparison (DB1 and DB2) as each being comprised of a number of data tables that are each comprised of a number of data entities of the same type. Each data entity is assigned a unique identification number, and also a name.

With reference to FIG. 2, the first step 30 in operation of the method of the invention is to generate a configuration file which sets out the parameters, selected by a user of the software, for the comparison.

In the preferred embodiment, the software for generating the configuration file is implemented as a graphical user interface (GUI), and the user can select options to tailor the comparison to their particular needs. In an alternative arrangement, the software is implemented as a XML-compliant editor.

For example, the software may allow the user to specify whether individual records are compared by name (i.e. a descriptive name assigned to a particular record) or by an identification number (id). In general both “id” numbers and names should be unique for each record in the database, but in practise it is common for similar or identical names to be given to different records, whereas id numbers tend to be truly unique in a given database for instances of any one particular entity type. Thus, in circumstances where the user suspects that any given name may not be unique, they can avoid problems by effecting a comparison (in a manner to be described below) on the basis of id numbers.

The software may also allow the user to tailor reports generated by the software to include particular types of changes. For example, the user may be able to instruct the software only to report one of unmodified, modified, deleted or inserted records, or alternatively to report any combination of these changes. If the user should opt to include modified records in the report, they may also choose whether the software should report characteristic or value changes or not.

The software may also allow the user to exclude or include specific types of data records, and to filter the report to include or exclude information such as any embedded coded data and/or its bedding.

In a highly preferred arrangement, the software will also allow the user to select the format in which they wish the report to be generated. For example, the user may opt to generate a report in any one or more of the following formats: TSV (text), CSV, RTF, HTML, MIF, etc.

Once the user has selected the particular options for the comparison, a configuration file (encompassing the user selections) is stored. The user may, on subsequent operations of the software of the invention, be invited to use a stored configuration file in preference to creating a new file.

The next step 32 in the process is for the user configuration file to be parsed, and by this we mean that each of the options available to the user is instantiated (i.e. created) as an object that is subsequently populated with values appropriate for the selection made by the user.

Once the configuration file has been parsed, the next step 34 in the process is for the two databases DB1 and DB2 to be parsed. For the purposes of this description it is assumed that DB1 and DB2 are each in an appropriate XML format. In the event that they are not appropriately formatted, then a further step will be required (prior to the database parsing step) in which the databases are converted into an appropriate XML format using whatever proprietary tools are provided with the database management software.

In this particular implementation the databases DB1 and DB2 are parsed by expressing them in an object-orientated format in memory. To implement this, the software generates object classes that correspond to the database tables (‘entity types’), individual objects which correspond to the rows of the table, and object characteristics for those individual objects that correspond to the fields (‘entity attributes’) of the tables. Advantageously, these object classes are generated from a representation of the schema of the database to be parsed and as a consequence the software is effectively independent of the database schema.

During the parsing of the XML database files, an object of the appropriate type is instantiated for each record (‘entity’) of its associated table, and the characteristic values for that object are set to the corresponding field values for that table record. As each object is created, a reference to that object is added to an entity list. The entity list references may simply comprise pointers to each individual entity record. A reference to the id number of the object is also saved in a hash which may form part of the entity list or comprise a separate record.

Hashing, or hash algorithms, are well known to those of ordinary skill in the art and will not further be described herein, except to say that a “hash” is generally defined as a scheme for providing rapid access to data items which are distinguished by a key—in this instance the id number of each object.

An entity list is created for each of the two databases DB1 and DB2 (those lists being referred to hereafter as an old list and a new list, respectively), and the data contained in the lists may simply comprise a pointer to each of the aforementioned entity records in the tables. In the preferred embodiment, the two lists are created simultaneously, but it will be apparent that they could alternatively be created one after the other.

Once the two lists have been created, the next step 36 of the process is to attempt to “pair” entities in the two lists. By this we mean that the software attempts to find, for each entity in the old list, a corresponding entity in the new list. The software pairs entities by creating a difference object for each entity in the list, and populates this difference object with the information about each of the two entities—namely the old entity and the new entity—including references to them and their position in the hierarchies of objects to which they belong (their so-called “lineage”). In the event that a new entity cannot be located for any given old entity, or a new entity is located which does not correspond to an old entity, the software simply populates the old or new information values, as appropriate, of the appropriate difference object with null values. Each entity reviewed by the software is marked as having been visited, and the pairing process (further details of which are provided below) terminates when all of the entities in each of the old and new entity lists have been visited.

As mentioned above, it is possible for the user to configure the software to include or exclude certain characteristics of the object entities, and as such the new and old characteristics of the difference objects may be tailored in accordance with the preferences saved in the configuration file.

Once all of the entities have been visited by the software, the next step 38 is to compare the old and new characteristics for each difference object created. In this comparison, the software compares for each characteristic of a given entity record the new and old values stored in the objects referred to by the difference object.

If the old and new values of each characteristic of a given entity record are identical, then that entity is determined to be unmodified as between the old and new database versions DB1 and DB2.

If the old and new values of one or more characteristics of a given entity record are determined to be different, then that entity is determined to have been modified as between the old and new database versions DB1 and DB2.

If the old values of each characteristic are all null values, then that entity is determined to be a new entity added to the new version of the database. Similarly, if the new values of each characteristic are all null values, than that entity is determined to be an old entity which has been deleted from the new version of the database.

Once each difference object created by the software has been considered, a report may be generated—in accordance with the options selected and saved by the user in the configuration file—that identifies one or more of: the new object records in DB2, the object records deleted from DB2 and the object records that have been modified as between DB1 and DB2. If chosen by the user, the new and old values of any modified characteristics may be reported.

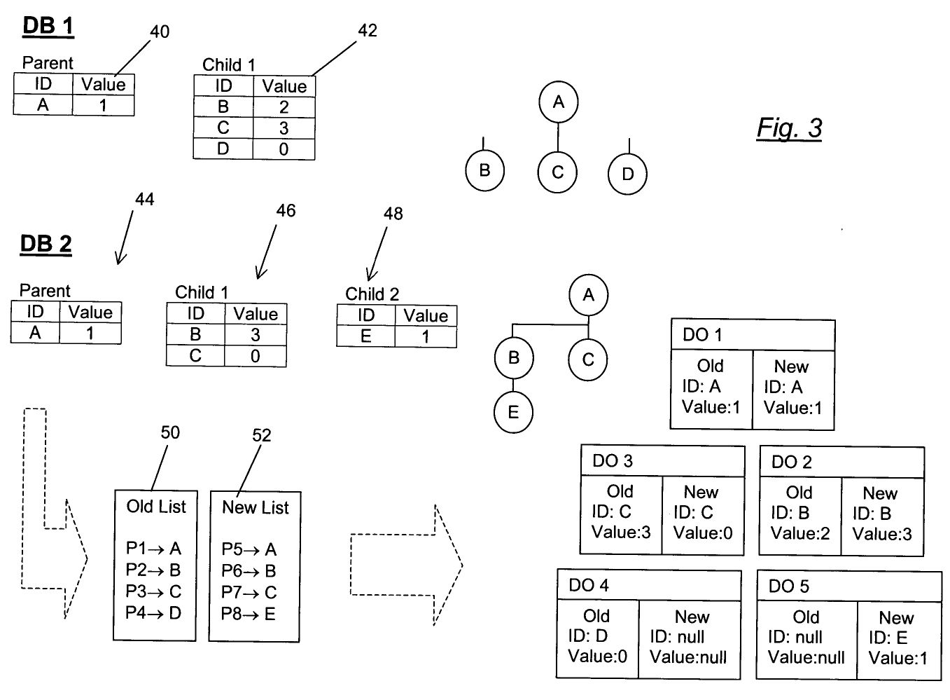

With reference now to FIG. 3, there is shown a pictorial representation of the method of the invention.

As shown, in this illustrative example database DB1 (the old database) is comprised of a parent object class 40 and a child object class 42 (both represented as tables) comprised of four discrete objects having object id's A to D, and values listed in the corresponding “value” columns of the tables. As shown pictorially alongside the tables, objects B, C and D are child objects of object A—the parent object.

Database DB2 (the new database) is comprised of a parent object class 44, a first child object class 46 and a second child object class 48 (all represented as tables) comprised of four discrete objects having object id's A, B, C and E, and values as listed in the corresponding “value” columns of the tables. As shown pictorially alongside the tables, objects B, C are child objects of object A—the parent object, and object E is a child object of object B.

As mentioned above, the database parsing process comprises the compilation of an old list 50 and a new list 52 which each include pointers (P1 to P8) to the objects instantiated from each class (table) of DB1 and DB2. As shown in FIG. 3, the old list 50 includes pointers P1 to P4 pointing respectively to objects A to D. The new list includes pointers P5 to P8 pointing, respectively, to objects A, B, C and E.

Although not shown in FIG. 3, the software also generates a hash list of objects keyed by ID number (or in this case, ID letter). The function of this list is only to speed subsequent retrieval of individual objects and as such it is inessential to the present invention, and will not further be described.

The next stage in the method comprises the abovementioned pairing process. In this stage, the software instantiates a difference object “DO” for each instantiated object in the old list, and stores a reference to the appropriate “old” object in an “old” list in the difference object instantiated therefor. In the example shown in FIG. 3, the software creates four difference objects, DO 1 to DO 4, in respect of the four entries in the “old” list.

Simultaneously, the software creates a list of difference objects and stores a reference to the instantiated objects therein. The software completes this process progressively for each object in the “old” list, starting with the first object listed.

As a difference object is instantiated for each object listed in the “old” list, the list is updated with markers indicating the objects which have been visited by the software.

The software, starting with the first object listed in the “old” list—in this case object A, traces the lineage of that particular object, and subsequently records that lineage in a list (not shown) comprised of a hash keyed. by lineage. Once again, a hash is employed simply for speed and efficiency purposes, and as such the use of a hash is not critical to the invention.

Lineage, as used herein, is intended to refer to the particular position of a given object in the hierarchical data structure of the database. In this instance the lineage of the first object listed in the “old” list is simply “Parent”—object A being the root object.

The software then proceeds to the next object in the “old” list and continues until the lineage of each and every object in the “old” list has been recorded.

Once the lineage has been determined for all the objects in the “old” list, the software then looks to the “new” list and computes the lineage for each object recorded in the new list, and records that lineage in an ordered list. As the lineages are recorded, the software marks each of the objects in the “new” list with a marker which indicates that that particular “new” object has been visited.

Starting with the first object listed in the “new” list, the software retrieves the associated lineage stored in the aforementioned list, and checks this lineage against the lineage of “old” objects referenced in the aforementioned difference objects.

If the software should determine that the retrieved lineage for that “new” object matches that referenced in the difference object, it is determined that the difference object corresponds to, and has a reference to, an “old” object having the same lineage as that “new” object—and hence that the “old” object is a potential match for the “new” object.

The software then retrieves the value of the discriminant of the “old” object, and compares this against the value of the discriminant of the “new” object. If these two values should match, then an actual match between the “new” and “old” objects is determined to have occurred and a reference to the “new” object is stored in a “new” list of the difference object which references the matching “old” object.

If no actual match is determined to have occurred, the software generates a new difference object, inserts a reference to that new object in the aforementioned difference object list, and populates a “new” list of that new difference object with a reference to the “new” object.

This process is completed for each and every object in the “new” list, and when completed each of the objects in the “new” and “old” lists will have been referenced in a difference object, and those difference objects will refer to “old” and “new” objects which match, “old” objects that have no counterpart “new” objects (i.e. those that have been deleted from DB 2), and “new” objects that have no counterpart “old” objects (i.e. those which have been added to DB 2).

In the example illustrated in FIG. 3, and as mentioned above, difference objects DO 1 to DO 4 have been instantiated in respect of pointers P1 to P4 in the “old” list. Difference object DO 5, on the other hand, has been instantiated in respect of pointer P8 in the “new” list.

Difference objects DO 1 to DO 3 have each been populated with references to matching “old” and “new” objects which have been determined to match on account of their corresponding lineage and id numbers. Difference object DO 4, on the other hand, includes only a reference to the “old” object D, as no counterpart object exists in the “new” list. Similarly, Difference object DO 5 includes only a reference to the “new” object E, as no counterpart object exists in the “new” list.

Looking now at each of the difference objects reference in FIG. 3, it is apparent from DO 1 that Object A is unmodified as between DB 1 and DB 2. Objects B and C (DO 2 & DO 3), on the other hand, have been modified as between DB 1 and DB 2, and their associated values have changed to 3 and 0, respectively. The “new” list of DO 4 is comprised entirely of nulls, and as such object D—the object referenced in DO 4—has been deleted from DB 2. Similarly, the “old” list of DO 5 is comprised entirely of nulls, and as such object E—the object referenced in DO 5—has been added to DB 2.

Once each of the objects in the “old” and “new” lists has been marked, the software then proceeds to generate a report based on the preferences indicated earlier by the user and saved in the aforementioned configuration file.

Considering the five difference objects referenced in FIG. 3, the following report could be generated —if desired:

REPORT

| | |
|---|---|
| Unmodified Entities: | Object id: A, Value: 1 |
| New Entities: | Object id: E, Value: 1 |
| Deleted Entities: | Object id: D, Value: 0 |
| Modified Entities: | Object id: B, old Value: 2, new Value: 3 |
| | Object id: C, old Value: 3, new Value: 0 |

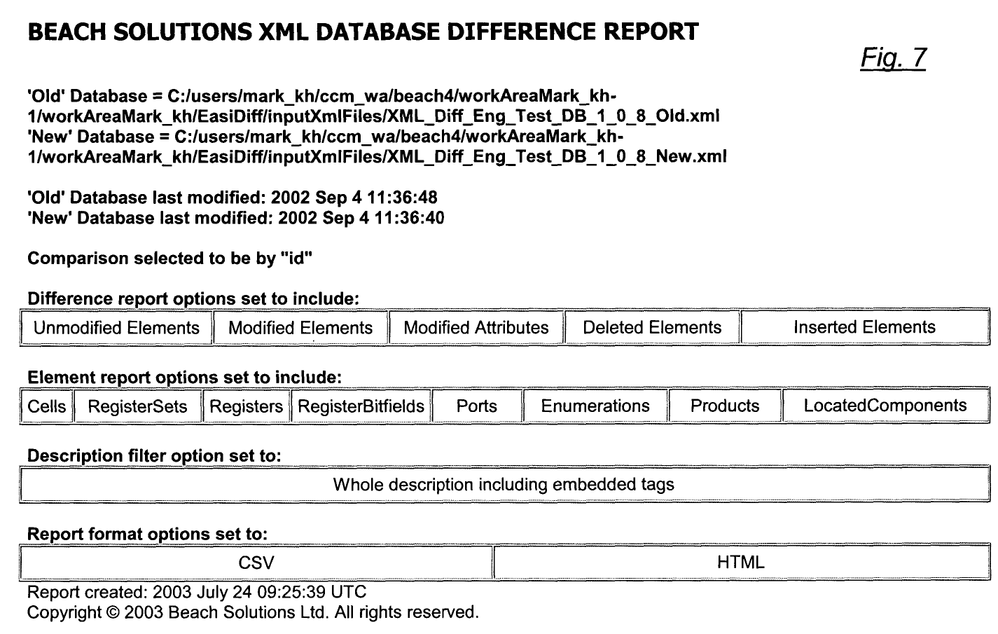

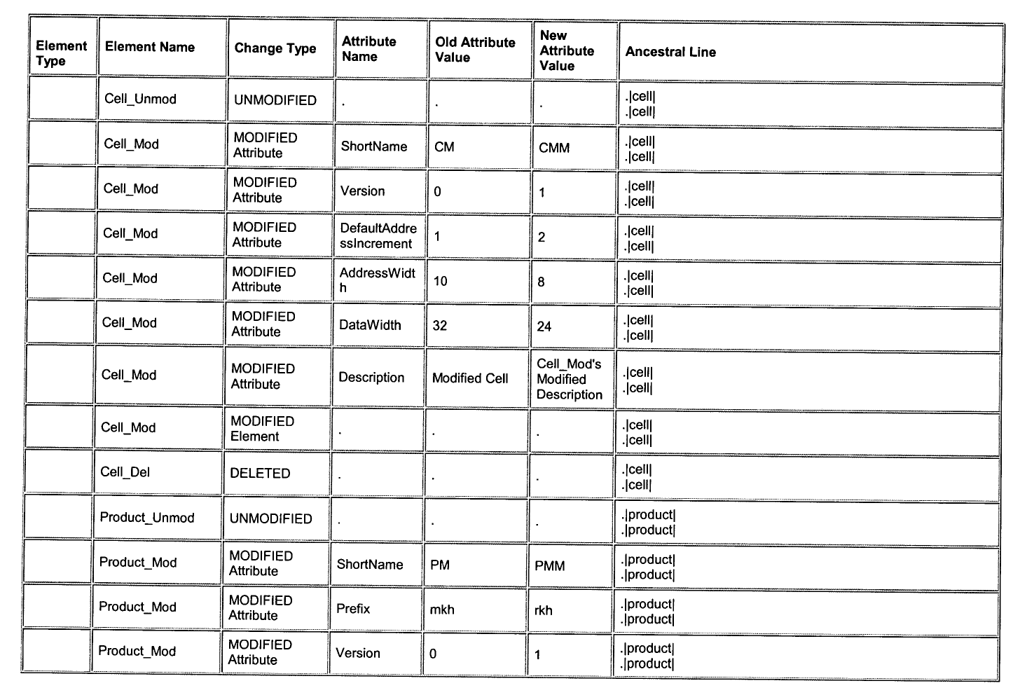

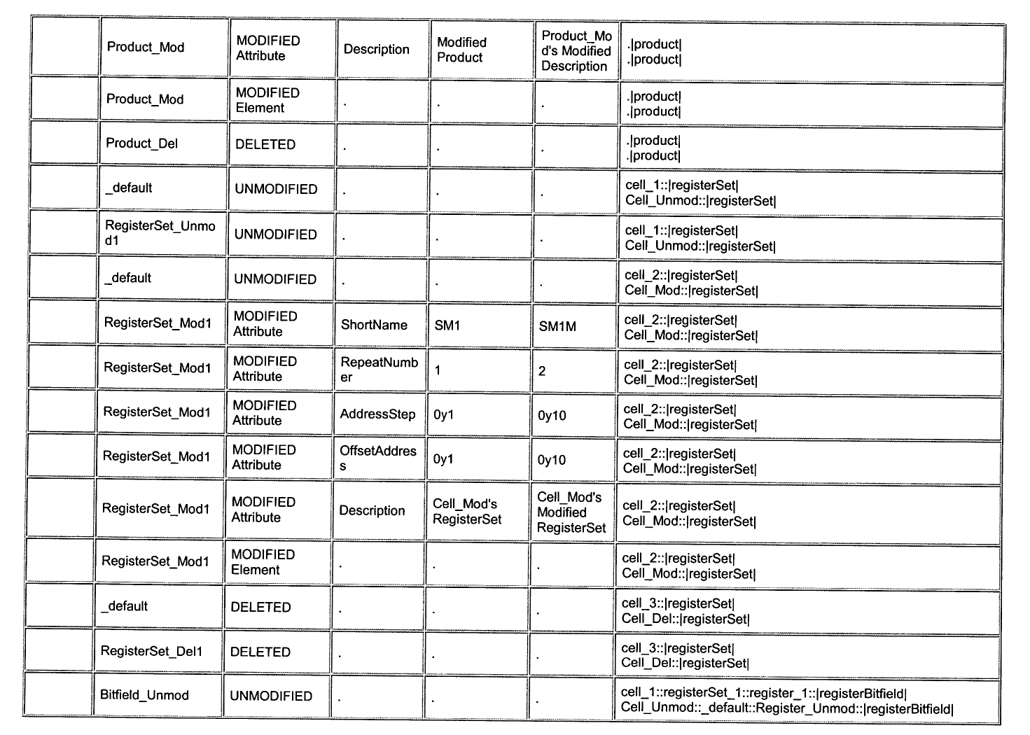

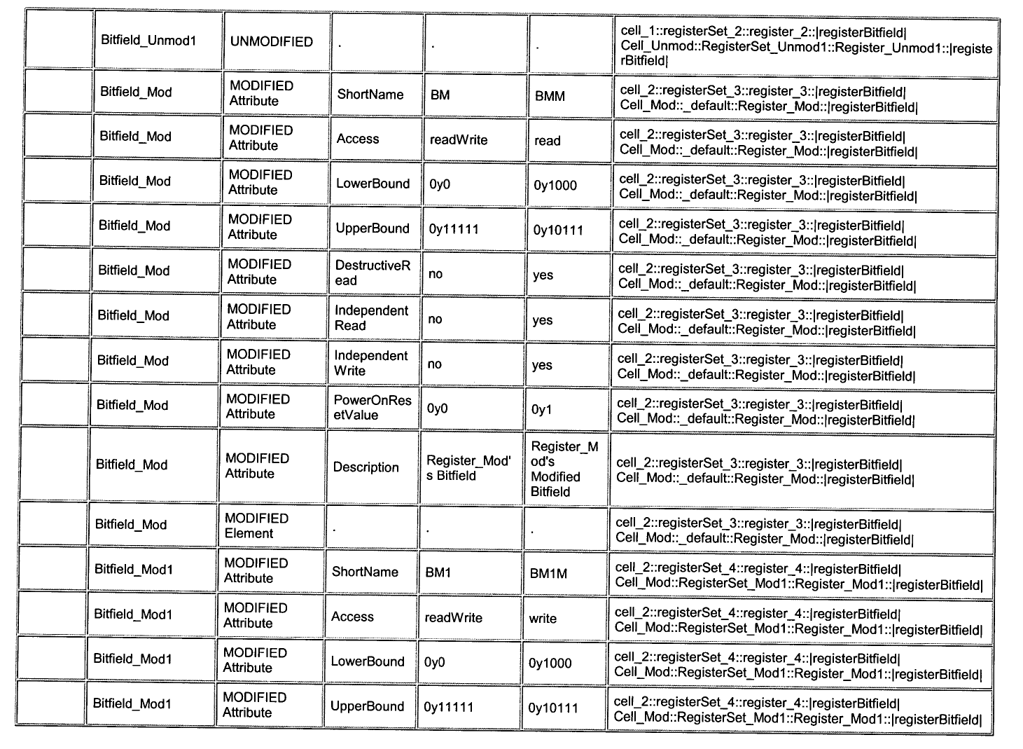

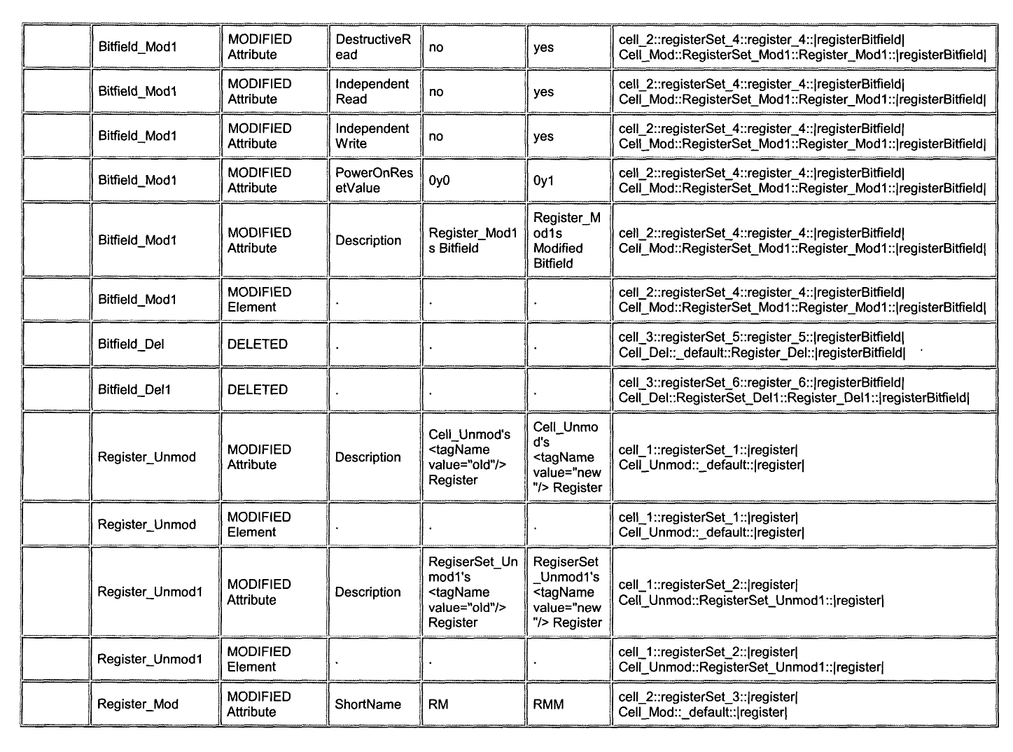

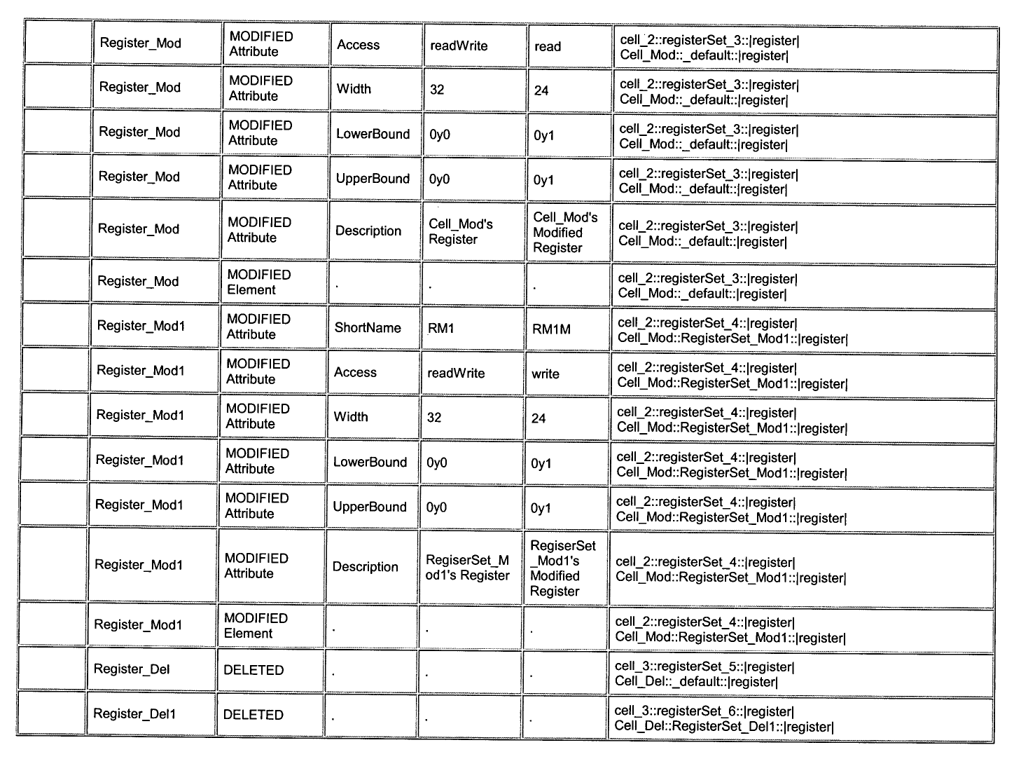

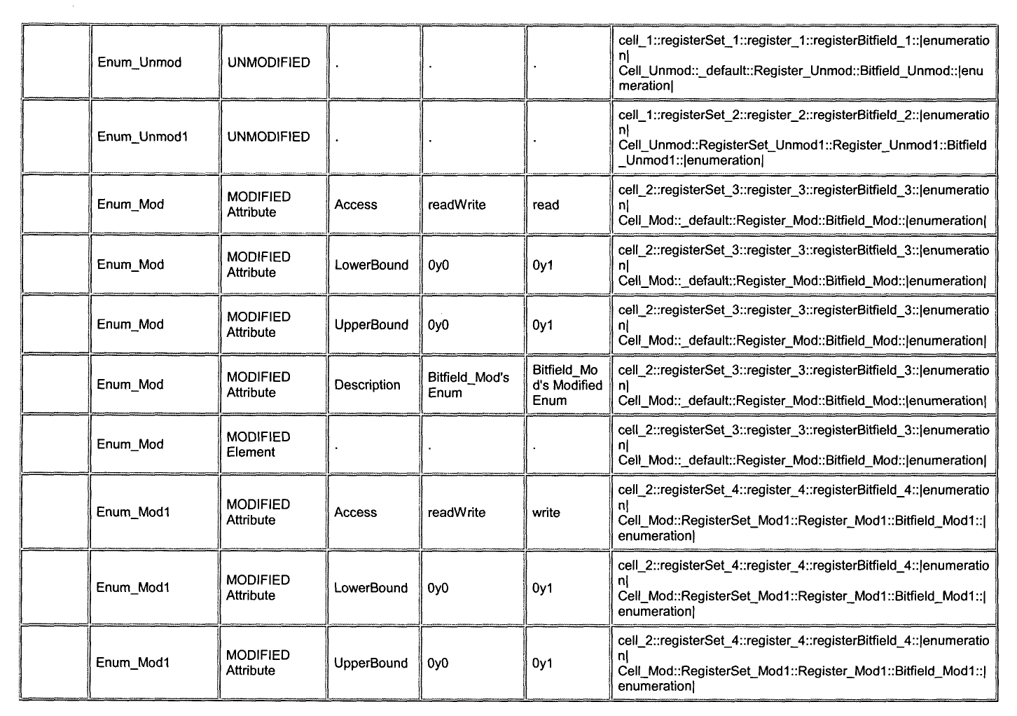

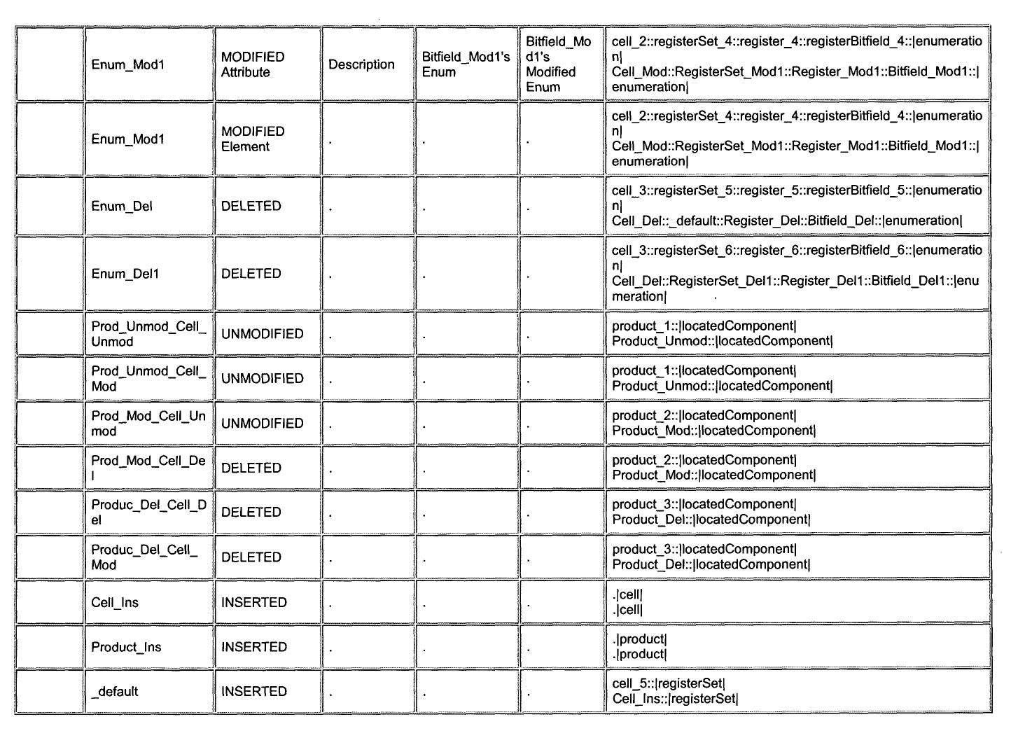

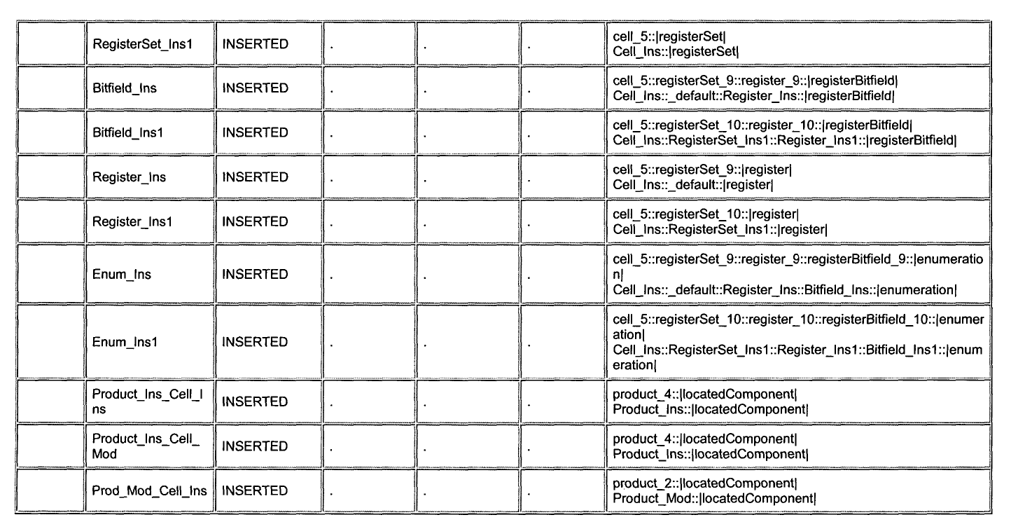

FIG. 7 (on sheets 6 to 14 of the drawings) is an actual report generated by software in accordance with an embodiment of the invention.

The bulk of the report is generated in a tabular format (see sheets 7 to 14). The table is preceded by a report “front page” which specifies the physical locations of the “old” and “new” databases, the date and time on which the “old” and “new” databases were last modified, and the discriminator chosen by the user for the purposes of the comparison (in this case the unique identifier “id”).

The front page also specifies all of the options selected by the user. In this instance, the user has opted to report elements which are—as between the old database and the new database—unmodified, modified, deleted, inserted and those which have had their attributes (characteristics) modified.

The user has also opted to include eight different element types in the report (cells, RegisterSets, Registers, RegisterBitfields, Ports, Enumerations, Products and LocatedComponents), to set the filter to include embedded tags, and to output the report in CSV and HTML formats.

As represented in the table on sheets 7 to 14, rows of the table represent—of the types selected by the user—one attribute for each modified element type, and entries for each unmodified, deleted or inserted element (as selected by the user). For each attribute, the following fields are reported: element type, element name, change type, attribute name, old attribute value, new attribute value and ancestral line (lineage) in each of the two databases. In the example illustrated the column “element type” has not been populated. In a real report this column would typically be populated with icons representing each different element type.

Thus, considering the table on sheet 7, it is apparent, that the element with element name “Cell_Mod” is designated as being a modified element, and is also designated as having the following attributes modified: ShortName, Version, DefaultAddressIncrement, AddressWidth, DataWidth, and Description.

In a highly preferred arrangement the “change types” reported are colour-coded to facilitate easy identification. For example, the change type “modified attribute” may be yellow, the change type “modified element” may be orange, the change type “deleted” may be red, the change type “inserted” may be blue, and the change type “unmodified” may be presented without colour.

A complete report, with all entity types and reporting options set can be used as an “audit sheet” for the changes between two databases for quality control or contractual purposes.

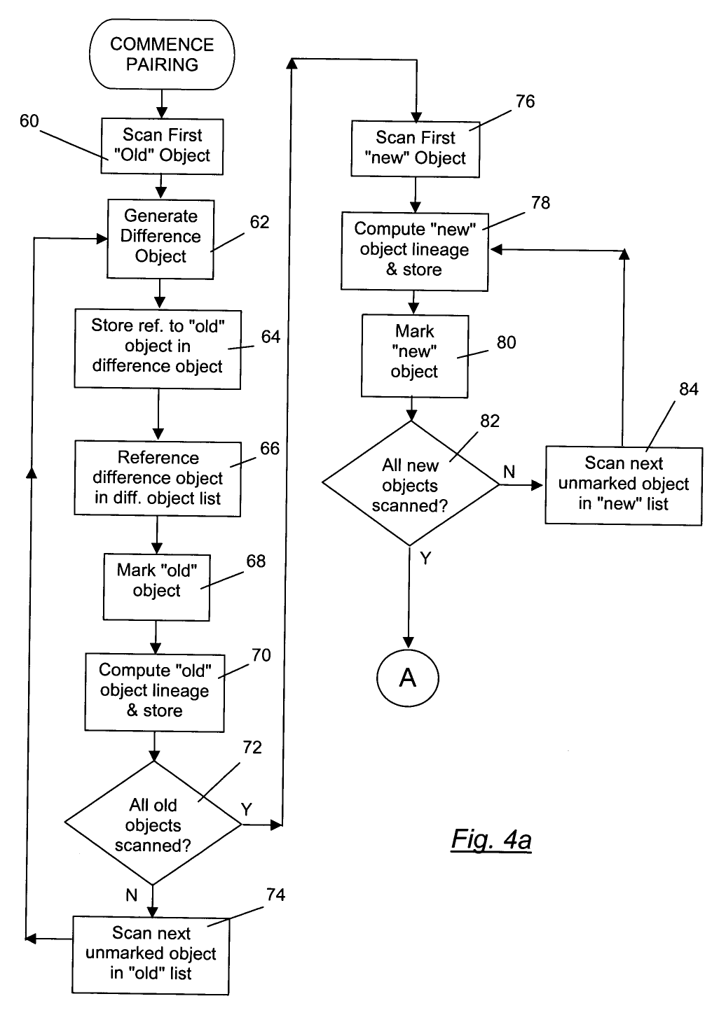

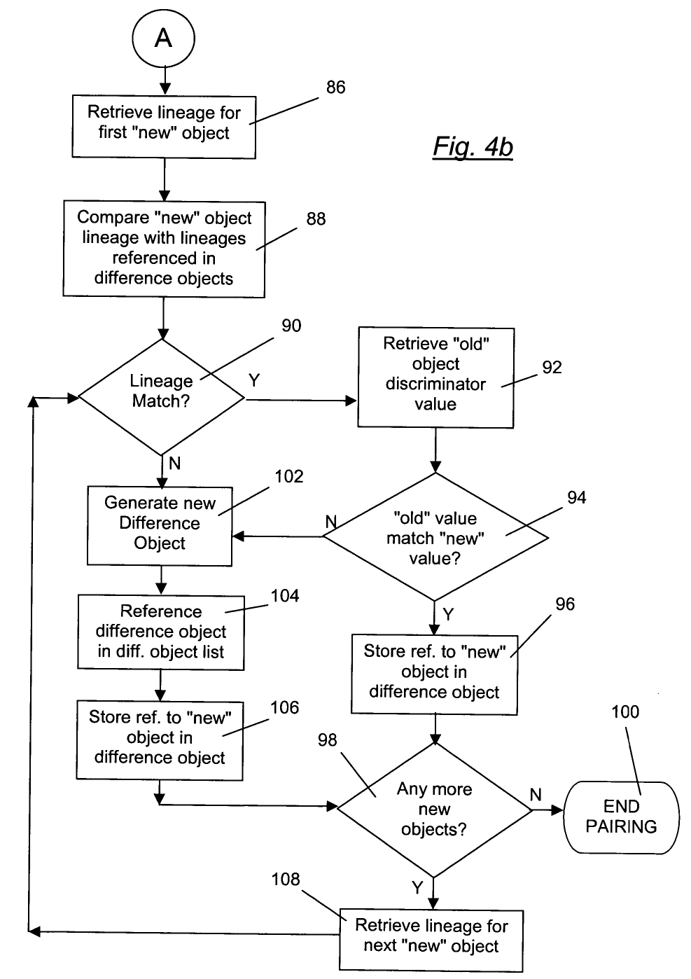

FIGS. 4a and 4b are flow diagrams setting out, in a more conventional manner, the steps of the aforementioned pairing process.

The process commences, step 60, with the scanning of the first object in the aforementioned “old” object list 50. A difference object is then generated (step 62) and a reference to the scanned “old” object is stored in the difference object (step 64).

A reference to the difference object is inserted in a list of difference objects (step 66), and the scanned “old” object is marked as having been processed (step 68). The lineage of that object is then computed and stored in a list of lineages (step 70).

A check is made to see whether there are any further objects in the “old” list (step 72), and if there are, processing continues to the next unmarked object in the “old” list (step 74), and subsequently loops to step 62 aforementioned.

Once all of the objects in the “old” list have been processed, the first object in the “new” list 52 is scanned (step 76) and its lineage is computed and stored (step 78). The “new” object is marked as having been processed (step 80), and a check is made to see whether there are any further objects in the “new” list 52 (step 82). If there are any further objects in the “new” list, processing proceeds to the next unmarked object in the “new” list (step 84) and subsequently loops to step 78 aforementioned. If all of the objects in the “new” list 52 have been visited, processing continues at “A” in FIG. 4b.

Referring now to FIG. 4b, processing continues with the retrieval of the lineage computed and stored in step 78 aforementioned for the first object in the “new” list (step 86). The retrieved lineage is then compared with the lineages stored (in step 70 aforementioned) for objects in the “old” list (step 88).

If the lineage of the “new” object should match one of those in the list of lineages stored for the “old” objects (step 90), the discriminator value for the “old” object associated with that lineage is retrieved (step 92), and that retrieved value is compared with the discriminator value of the “new” object (step 94). If the values should match, a reference to the “new” object is stored in the difference object that references the “old” object with the matching discriminator value and lineage (step 96), and a check is made to see whether there are any further “new” objects to be processed (step 98). If there are no further “new” objects to be processed, the pairing process is deemed to have been completed (step 100).

If, in step 90, the lineage of the “new” object should be determined not to match any of the lineages stored in respect of the “old” objects, a new difference object is generated (step 102), and a reference to that new difference object is stored in the difference object list aforementioned (step 104). A reference to the “new” object is then stored in the new difference object (step 106) and processing continues at step 98.

If, in step 98, it should be determined that there are further “new” objects to be processed, the lineage for the next object in the “new” list is retrieved (step 108) and processing continues at step 90 aforementioned.

If, in step 94, the discriminator value of the new object is determined not to match the discriminator value of the old object that shares the lineage of the new object, the new object is determined to be an addition to the database and processing continues at step 102 aforementioned.

It will be appreciated from the above, that the teachings of the invention provide a mechanism by means of which the differences (if any) between two databases can reliably be identified and reported in such a way that the user is able to determine, not only whether or not a given database has been modified, but also the particular way in which that database has been modified.

It will also be apparent that the use of lists, as hereinbefore described, greatly facilitates the processing of any given database. As such the teachings of the invention provide for a remarkably speedy determination of database differences. This contrasts with the systems previously disclosed that tended to employ relatively cumbersome and unwieldy algorithms that slowed the differencing process quite dramatically.

### DETAILED DESCRIPTION

There now follows a detailed description of one specific implementation of the principles of the invention as generically described above. Once again, this detailed description is provided solely for purposes of illustration and is not to be taken as limiting the spirit or scope of the invention in any way.

As mentioned previously, a preferred embodiment of the invention provides a standalone tool to compare the differences between two databases. For convenience we refer to the two database versions as the ‘older’ and ‘newer’, but as mentioned above it will be apparent that the teachings of the invention are not limited to comparing two databases or to comparing two versions of the same database.

The following detailed description of the present invention is based, by way of illustrative example only, on the comparison of XML databases used to describe embedded systems. These databases can, for example, be created using the EASI-Studio™ tools from Beach Solutions of Merlin House, Brunel Road, Theale, Reading, RG7 4AB, United Kingdom. The examples provided hereafter rest upon the idea that most designs are hierarchical and use a model often found in electronic engineering that consists of a system containing one or more sub-systems recursively. In this particular illustrative example the underlying database schema is proprietary and is known as the Beach Solutions EASI-Studio Schema (“the Schema”).

Schema Object

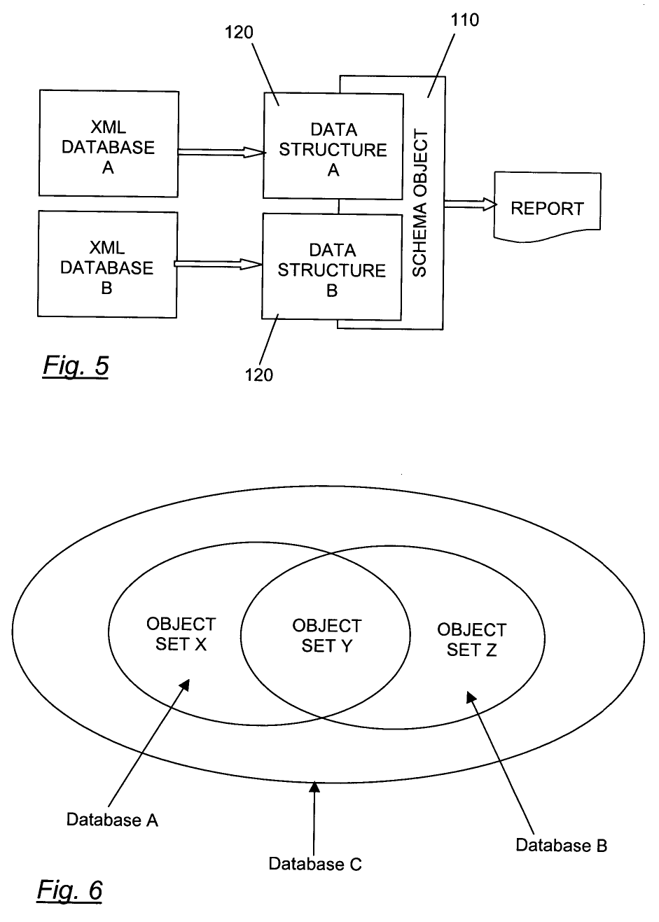

FIG. 5 is an overview diagram of the tool's process. To use the tool, a thorough object-oriented analysis must be carried out as part of the schema design. In the preferred arrangement, there is provided, in a form that is easily accessible and meaningful, an object that describes the database schema and passes this information to the tool. This is referred to as the schema object 110.

The first step of the process is to obtain the data model from the schema object. From this object, the tool determines what entity types exist and what attributes each type has.

Entity types, data types and relationships are often added as the design schema grows. The tool can compare (and hence differentiate) any two (or more) databases conforming to the whole schema, even though one or both of the databases may also conform to a previous schema version. In other words, FIG. 6. illustrates that it is possible to compare databases that individually contain objects from any one or more of the sets X, Y, and Z.

If multiple schema objects are made available to the tool, the tool can automatically detect which schema is used before parsing in the data for each database.

Running the Tool

The tool may be operable in two modes: command-line only mode and Graphical User Interface (‘GUI’) mode. It is fully automatic in the former. In the latter, it is essentially automatic and processing is only interrupted to allow the user to select options. It operates completely independently of the originating RDBMS.

Preparing Databases to be Compared

For times when the data being compared is not represented in XML, a further step is required to write each database out into two corresponding XML files using whichever proprietary tools are available with the particular RDBMS. On the other hand, if the database preparation tools are XML-based, no data preparation will be necessary.

Configuring the Tool

As databases may be very large and only some of the data may be of immediate interest to the user, it is highly desirable to offer, store and recall user-selectable options for comparison, reporting and report formatting.

These user settings can be stored in an XML file known as the configuration file (‘config file’) and can be created by hand in any text editor or XML-compliant editor. When the settings are defined by the appropriate option selection using the tool's built-in GUI, the tool can automatically save these settings in the configuration file.

The tool may present options to the user, which allow him to select which entity type or types to compare, which similarities and/or differences to report, and how to report them. This includes optional reporting of unmodified, modified, deleted or inserted entities, and (for modified entities) their attribute value changes. Additional options, specific to each entity type, allow the user to select for which combination of entity types to compare attribute or attributes for value changes. For each entity, its position in the hierarchy is reported.

Throughout execution of the comparison and reporting process the user's option selections will be taken into account. In the preferred arrangement, these options fall into five groups:

(1) Discriminant: Typically, compare by ‘name’ or by ‘id’.

(2) Difference Class: Report unmodified, modified, deleted or inserted objects, or any combination. Where modified, report attribute value changes or not.

(3) Difference Type: Report to include one or any combination of the existing entity types.

(4) Filtering: Report embedded coded data and/or its bedding, or neither.

(5) Reporting Format: Report in one or more of the available implemented formats (e.g. TSV (text), CSV, RTF, HTML, MIF, etc).

The first action taken by the tool is to parse the configuration file containing the default (or most recently saved) user options.

As the configuration file is being parsed the parser instantiates the required configuration objects on the fly and populates them with the various option values. In the GUI mode only, the graphical option-selectors are set in accordance with the option values from the configuration objects and the GUI is then displayed.

Parsing the XML and Populating the Data Structure

In the preferred arrangement, and prior to the comparison, the XML database files are checked for the presence of characters with an encoding incompatible with the parser, any such character being translated to an equivalent character with compatible encoding.

As illustrated by FIG. 1, the tool uses two data structures 120 to hold the data for comparison, one for each XML database. The data structures are created in a form that facilitates inspection and comparison. Of the several possible forms, an object-oriented structure is used:

object classes corresponding to the database tables (‘entity types’)

object class characteristics corresponding to the fields (‘entity attributes’)

These object classes are generated from the schema object thus making the tool independent of the database schema.

During the parsing of the XML database file, the following occurs:

1. An object class of appropriate type is instantiated for each record (‘entity’) of its associated table.

2. The characteristic values for that object are set to the corresponding field values for that record.

3. A reference to each instantiated object is added to one or other of two object lists: one each for the older and newer databases respectively. At the same time, for speed and efficiency of later search, a reference to the object is also saved in a hash keyed by object identity.

The Pairing Process

The list of ‘old’ (older) data objects is scanned, a new difference object of appropriate type is created for the old object (i.e. its class is instantiated), a reference to the old object is stored on the associated difference object, a reference to the new difference object is placed in the list of difference objects, and the old object is marked as having been ‘touched’ (visited). This list consequently contains objects which potentially are unmodified, modified or deleted.

At the same time, the ancestral line (‘lineage’) of the old object is traced and recorded as an ordered list. A lineage is essentially a path or branch of a tree. In this particular implementation, the list is in most-ancient-first (i.e. hierarchically ‘top down’) order and is implemented as a string of symbol-separated values. The values used are those of the chosen discriminator (e.g. id or name), for each ancestral entity type, and for lineage-matching convenience includes the type for the object itself. Note that the lineage could be implemented in one of several other ways, e.g. a least-ancient-first (i.e. hierarchically ‘bottom-up’) set of values in an array.

For speed and efficiency of search for comparing lineage when later attempting to pair objects, a reference to the difference object in hand is saved in a hash keyed by lineage (in this case, the old object's lineage). This is beneficial to the efficiency (and hence speed) of pairing.

Then the list of ‘new’ (newer) objects is scanned. This list contains objects which potentially are unmodified, modified or inserted. For each new object, the ancestral line (‘lineage’) of the object is traced and recorded as an ordered list, and the object is marked as having been ‘touched’. A check is made for the existence of a difference object with this lineage by looking for a defined reference to a difference object in the hash of lineages. If one exists, this difference object corresponds to (and has a reference to) an old object having the same lineage and a potential partner has been found. The type of the old object and the value of its discriminator are retrieved and, if they agree with those of the new object under consideration, an actual partner has been found. A reference to the new object is stored in the associated difference object.

If no actual partner has been found, a new difference object of appropriate type is created (its class is instantiated) for the new object, a reference to the new difference object is placed in the list of difference objects, and a reference to the new object is stored on the new difference object. This completes the pairing process.

Comparing the Lists and Objects

The comparison process itself follows. For efficiency, reporting may be carried out as part of this process (‘on the fly’).

The first phase involves scanning the list of difference objects and for each difference object its references to old and new objects are inspected for definition. If only one is defined, the object referred to has either been deleted (in the case of an old object) or inserted (in the case of a new object). Its details are retrieved and the deletion or insertion as appropriate is reported.

If both references are defined, the objects referred to have been paired but may or may not be involved in a modification. The second phase involves comparing the pair of values for each and every attribute on these objects:

If the values of a pair do not differ the object can be reported as unmodified.

If the values of any pair differ the object can be reported as modified and all attribute value changes can be reported.

In order validly to compare a pair of objects from two databases, truly corresponding objects need to be identified. This requires some means of discrimination between entities. One of the benefits of the tool is that you can compare the objects by ‘name’ or ‘id’. This means even if it is the name of an object has changed, the objects can still be paired by the unique ID assigned to the object. Each object in the database is assigned a unique id. This means that if the user has changed the name of the object in the newer database, when comparing by name, the tool would consider the object as an insertion. When in actual fact, the object has simply been modified because the ID will still be the same. The GUI will present the option of comparing by name or id.

Modifications

Under certain circumstances where conventional discriminators may not be preserved, it is possible to add a further discriminator to every entity type in the schema, that further discriminator being a globally unique identifier (GUID)—such discriminators being well known to those persons skilled in the art.

Whilst preferred embodiments of the invention have been described above, it should be noted that these embodiments have been described by way of illustrative example only. Various modifications and alterations of the disclosed embodiments as well as alternative embodiments of the invention will become apparent to one skilled in the art following a reading of the application. It is important to note therefore that the accompanying claims are intended to cover any such modifications or alternatives that fall within the spirit and scope of the invention.

As an example of one alternative, it will be apparent to persons skilled in the art that the hardware and software infrastructure described herein is not the only means by which the teachings of the invention may be implemented. For this reason it is important to note that the present invention is not limited to the particular infrastructure described, and that other alternative infrastructures may instead be employed if desired, without loss of functionality.

It will also be apparent that the system of the invention could be coded in a language other than an object orientated programming language. Accordingly, whilst the description refers to aspects of an object orientated language, it will be understood by those persons skilled in the art that the system described herein may be coded in any other programming language (such as procedural language for example) and thus that the present invention is not limited to implementation with an object orientated programming language. It will also be understood that whilst it is preferred that the invention is implemented by software, it could instead be implemented (at least in part) in hardware comprising, for example, one or more application specific integrated circuits.

It will also be apparent that whilst the particular embodiments described above have dwelled on the comparison of two versions of the same database, the teachings of the present invention can be extended generally to the comparison of any number of databases. These databases can comprise different versions of the same database or different databases. Typically, different databases will have fewer entities in common than different versions of the same database, and may have even fewer (potentially zero) entity types in common.

Finally, it should be noted that whilst certain combinations of features have explicitly been enumerated in the accompanying claims, the present invention is not limited to those particular combinations but instead extends to any combination or permutation of features described or claimed herein.

What is claimed is:

1. A method of comparing first and second databases that are each comprised of a plurality of entities having one or more characteristics, said entities being grouped into a plurality of data classes in each said database each representative of a particular entity type, the method comprising:
(i) for each said data class of said first and second databases, compiling a list representative of the entities occurring within that class and any attributes for each said entity;
(ii) identifying and comparing corresponding data classes for each of said first and second databases; and
(iii) identifying on the basis of said comparison differences between corresponding entities of said corresponding data classes.

2. A method according to claim 1, wherein said first and second databases are relational databases.

3. A method according to claim 2, wherein each structure of said first and second databases may be described by means of a schema.

4. A method according to claim 3, wherein said first and second databases conform to substantially the same schema.

5. A method according to claim 3, wherein said first and second databases conform to different schemas.

6. A method according to claim 3, wherein said first and second schema conform to different versions of the same schema.

7. A method according to claim 1, wherein said first and second databases are capable of being represented in XML file format.

8. A method according to claim 1, wherein said identifying step additionally comprises identifying entities that have been added to one or other of said first and second databases.

9. A method according to claim 1, wherein said identifying step additionally comprises identifying entities that have been deleted from one or other of said first and second databases.

10. A method according to claim 1, wherein said differences between entities include one or more of:
(a) the absence of a value of a said entity characteristic in one entity of corresponding entities in said first and second databases;
(b) a modification of a value of a said entity characteristic in one entity of corresponding entities in said first and second databases.

11. A method according to claim 1, comprising the additional step—in circumstances where said databases conform to an identical schema or different versions of a schema—of automatically detecting the identity of said schema.

12. A method according to claim 1, wherein said compiling step includes the steps of reviewing said databases for characters with an encoding incompatible with the parser, and translating any such character to an equivalent character with compatible encoding.

13. A method according to claim 1, wherein said compiling step includes the step of parsing each of said first and second databases.

14. A method according to claim 13, wherein said parsing step comprises instantiating an object class of appropriate type for each entity.

15. A method according to claim 14, wherein an object is instantiated for each entity of said first and second databases.

16. A method according to claim 15, wherein the list compiled for said first database includes entities of said first database, and the list compiled for said second database includes entities of said second database.

17. A method according to claim 15, wherein said identifying and comparing step includes a step of instantiating a difference object for each entity listed in one of the lists for said first and second databases.

18. A method according to claim 17, further comprising the step of populating each said difference object with a reference to the corresponding entity object in said one list.

19. A method according to claim 18, wherein for speed and efficiency of later searching, a reference to each said entity object is created in a hash keyed by object identity.

20. A method according to claim 18, comprising the step of computing a lineage (recursive parenthood) for each said entity object in said one list.

21. A method according to claim 20, comprising storing said computed lineages in a lineage list.

22. A method according to claim 21, wherein for speed and efficiency of later searching, a reference to said difference object is saved in a hash keyed by lineage.

23. A method according to claim 22, further comprising computing a lineage (recursive parenthood) for each entity of said other of the lists for said first and second databases.

24. A method according to claim 23, wherein said comparing step includes comparing the computed lineages for each entity of said other of the lists with the lineages computed for the entities in said one list.

25. A method according to claim 24, wherein in the event of a match between a computed lineage for an entity of said other of the lists and a lineage computed for an entity in said one list, a potential entity match is determined to have occurred.

26. A method according to claim 25, wherein in the event of a potential entity match occurring, a unique identifier for each potentially matching entity is retrieved and compared, and an actual match is determined to have occurred if the unique identifiers should be determined to match.

27. A method according to claim 26, wherein in the event of an actual match occurring, the difference object corresponding to the matched entity referenced in said one list is populated with a reference to the matched entity referenced in said other list.

28. A method according to claim 26, wherein in the event of an actual match not occurring, a difference object is instantiated for said unmatched entity in said other list.

29. A method according to claim 28, wherein said difference object is populated with a reference to said unmatched entity from said other list.

30. A method according to claim 29, wherein for speed and efficiency of later searching, a reference to said difference object is saved in said hash keyed by lineage.

31. A method according to claim 29, wherein said identifying step includes inspecting each said difference object for definition of the entity object or objects referenced therein.

32. A method according to claim 31, further comprising the step of determining an entity addition or deletion, as appropriate, to have occurred on identification of a said difference object with a single reference to an entity object.

33. A method according to claim 31, wherein said identifying step includes in circumstances where a said difference object includes a reference to two entity objects, retrieving and comparing each characteristic of said entity objects.

34. A method according to claim 33, further comprising the step of reporting, as differences, modifications, additions and/or deletions of characteristics of said two entities.

35. A method according to claim 34, further comprising reporting, in the case of a modification, the characteristic of each of said two entities.

36. A method according to claim 1, further comprising the step of presenting options to a user concerning the manner in which the first and second databases are to be compared.

37. A method according to claim 36, wherein said user is capable of choosing one of a number of identifiers for subsequent use in entity matching.

38. A method according to claim 37, wherein said identifiers comprise for each said entity one or more of: a name, a serial number by entity type (table key), or a globally unique identifier (GUID).

39. A method according to claim 38, wherein said options are provided to said user by means of a graphical user interface or a configurable XML file.

40. A method according to claim 39, wherein said user is also capable of selecting which entity types and characteristics are compared.

41. A method according to claim 39, wherein said user is capable of limiting comparison to specified parts of each of said first and second databases.

42. A method according to claim 39, wherein a user's option selections are accepted via a parsable configuration file in XML format.

43. A method according to claim 42, wherein GUI-modified options can be stored in a parsable configuration file in XML format.

44. A method according to claim 43, wherein said options are instantiated as configuration objects.

45. A method according to claim 1, further comprising the step of automatically generating a report of any identified differences.

46. A method according to claim 45, wherein said report can be generated in one or more of a plurality of file formats, each being selectable by a user.

47. A method according to claim 26, wherein said comparing step employs fuzzy matching to permit automated pairing of entities of identical type but of only similar attribute values.

48. A method according to claim 47, wherein the extent of fuzzy matching permitted is user selectable.

49. A computer program comprising one or more software portions which, when executed in an execution environment, are operable to perform the method steps set out in claim 1.

50. A storage medium encoded with machine readable computer program code for comparing first and second databases that are each comprised of a plurality of entities having one or more characteristics, said entities being grouped into a plurality of data classes in each said database each representative of a particular entity type; wherein, when the computer program code is executed by a computer, the computer performs the steps of:
i) for each said data class of said first and second databases, compiling a list representative of the entities occurring within that class and the attributes for each said entity;
(ii) identifying and comparing corresponding data classes for each of said first and second databases, and
(iii) identifying on the basis of said comparison differences between corresponding entities of said corresponding data classes.

51. A comparator for comparing first and second databases that are each comprised of a plurality of entities having one or more characteristics, said entities being grouped into a plurality of data classes in each said database each representative of a particular entity type, the comparator comprising:
(i) a first module which is operable, for each said data class of said first and second databases, to compile a list representative of the entities occurring within that class and the attributes for each said entity;
(ii) a second module that is operable to identify and compare corresponding data classes for each of said first and second databases, and
(iii) a third module which is operable to identify, on the basis of said comparison, differences between corresponding entities of said corresponding data classes.

52. A comparator according to claim 51, implemented in hardware.

53. A comparator according to claim 51, wherein said hardware comprises an application specific integrated circuit.

54. A comparator according to claim 51, implemented in software.

55. A storage medium encoded with machine readable computer program code for comparing a first older database and a second newer database each conforming to different versions of a database structure schema, said first and second databases each being comprised of a plurality of entities having one or more characteristics; wherein, when the computer program code is executed by a computer, the computer performs the steps of:
(i) automatically generating object-orientated data structures from schema objects relating to said schema versions;
(ii) parsing said first and second databases;
(iii) populating instances of said data structures with instances of the appropriate entities for each said database;
(iv) generating lists of entities for each entity type instanced in the said data structures for each said database;
(v) pairing corresponding entities in said lists;
(vi) populating a third instance of said data structures with instances of appropriate difference entity types;
(vii) storing in said difference entity types and hence in said third data structure the results of said pairing;
(viii) scanning said results of said pairing to determine which entities in said first database have been deleted, which entities in said second database have been inserted, and which entities are common to said first and second databases;
(ix) comparing characteristics of said common entities to determine which of the said common entities have been modified and which remain unmodified; and
(x) reporting said deletions, insertions, modifications, non-modifications and results of said characteristic comparisons.

56. A method for comparing a first older database and a second newer database each conforming to different versions of a database structure schema, said first and second databases each being comprised of a plurality of entities having one or more characteristics, the method comprising the steps of:
(i) automatically generating object-orientated data structures from schema objects relating to said schema versions;
(ii) parsing said first and second databases;
(iii) populating instances of said data structures with instances of the appropriate entities for each said database;
(iv) generating lists of entities for each entity type instanced in the said data structures for each said database;
(v) pairing corresponding entities in said lists;
(vi) populating a third instance of said data structures with instances of appropriate difference entity types;
(vii) storing in said difference entity types and hence in said third data structure the results of said pairing;
(viii) scanning said results of said pairing to determine which entities in said first database have been deleted, which entities in said second database have been inserted, and which entities are common to said first and second databases;
(ix) comparing characteristics of said common entities to determine which of the said common entities have been modified and which remain unmodified; and
(x) reporting said deletions, insertions, modifications, non-modifications and results of said characteristic comparisons.
